(19) United States
(12) Patent Application Publication
(10) Pub. No.: US 2004/0099076 A1
(43) Pub. Date: May 27, 2004

(54) Gear motor assembly

(76) Inventors: Igor Haskin, Glenview, IL (US); Erich Kothe, Schaumburg, IL (US)

Correspondence Address: SONNENSCHEIN NATH & ROSENTHAL LLP, P.O. BOX 061080, WACKER DRIVE STATION, SEARS TOWER, CHICAGO, IL, 60606-1080, US

(21) Appl. No.: 10/205,083

(22) Filed: Jul. 25, 2002

(51) Int. Cl. F16H 1/16

(52) U.S. Cl. 74/425

(57) ABSTRACT

The present invention is a gear motor assembly for use in connection with electromechanical devices. The gear motor assembly provides high torque output, can be utilized in a small physical space and permits backdrive in the output shaft of the motor. The gear motor assembly includes a conventional DC motor having a first helical gear mounted to an output shaft of the DC motor. The first helical gear operably engages a second helical gear generally at a right angle. The second helical gear is linked by a transmission shaft to a third pinion. The third pinion operably engages a first cluster gear, which operably engages a second cluster gear. The second cluster gear then engages an output gear, which mounts a drive shaft. The first and second helical gears, the third pinion, the first and second cluster gear and the output gear form a gear train that wraps around the DC motor. The DC motor and the gear train are mounted within a housing or gearbox.

### BACKGROUND OF THE INVENTION

1. Field of the Invention

The present invention generally relates to a gear motor and, in particular, a motor for use with electromechanical devices, such as ice crushers and the other similar devices requiring high torque output motors in small areas.

2. Description of the Related Art

Electromechanical devices such as ice crushers and ice dispensers in freezers and refrigerators are often powered by small motors that take the form of gear motors. Such gear motors may also have other applications, such as in vending machines, washing machines and other electromechanical devices that require motors providing high torque output in a small physical area. With the continuing objective of minimizing the size of such motor assemblies, it has been a constant struggle to design a motor assembly for use with such devices that not only produces the required high torque output but that makes efficient use of the space within the devices.

It is known in the art that the physical space of the gear motor can be minimized by configuring the first stage gears at ninety degrees (90°) measured by the angle between the axis of the motor's output shaft and the first stage gear. Several attempts have been made to design motors for small spaces by configuring the first stage gear at ninety degrees (90°). These designs have not, however, provided for a gear motor assembly that provides first stage gears in the gear train that permits backdrive, (i.e. to relax the gears). While in certain applications, such as vending machines, backdrive may be undesirable, backdrive may be advantageous for applications such as ice crushers and ice dispensers in freezers and refrigerators and has proven to help minimize jamming conditions, permit removal of jammed ice cubes, as well as avoid premature motor failure caused by motor burnout.

### SUMMARY OF THE INVENTION

Accordingly, the present invention provides a gear motor assembly that has high torque output, that can be utilized in a small physical space and that permits backdrive in the output shaft of the motor. The gear motor assembly of the present invention includes a conventional DC motor having a first helical gear mounted to the output shaft of the DC motor. The first helical gear operably engages a second helical gear at typically a right angle. This first and second helical gear design permits backdrive in the DC motor output shaft. The second helical gear is then linked by a transmission shaft to a third pinion gear. The third pinion gear operably engages at least one cluster gear, which drives an output gear having a drive shaft mounted thereto. The first and second helical gears, the third pinion, the cluster gear and the output gear form a gear train that wraps around the DC motor to make efficient use of space. The DC motor and the gear train are all mounted within a housing or gearbox.

### BRIEF DESCRIPTION OF THE DRAWINGS

A more complete appreciation of the invention and many of the advantages thereof will be readily obtained as the same becomes better understood by references to the detailed description when considered in connection with the accompanying drawings, wherein:

FIG. 1 is an exploded view of the gear motor assembly of the present invention;

FIG. 2 is top view of the gear motor assembly as illustrated with the top cover of the gearbox removed; and

FIG. 3 is a side view of the gear motor assembly as illustrated with the top and bottom cover of the gearbox removed.

### DETAILED DESCRIPTION OF THE PREFERRED EMBODIMENT

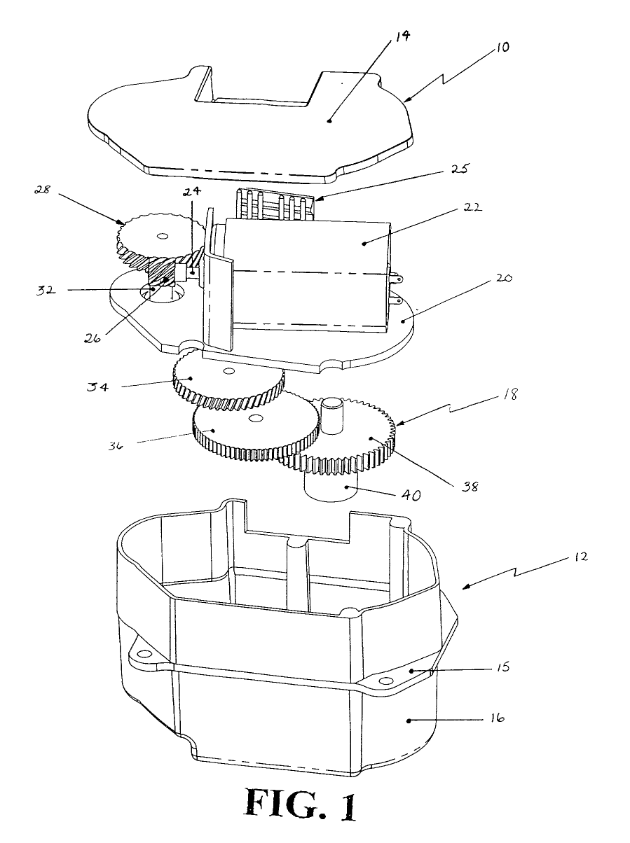

FIG. 1 is an exploded view of one embodiment of the gear motor assembly 10 of the present invention. As illustrated by FIG. 1 the entire assembly is encased in a gearbox 12, comprising a top cover 14, a bottom cover 16 and a gear cover 20. The top cover 12 is typically secured to the bottom cover 16 via screws, adhesive or other interlocking mechanism. The gear cover 20 is supported between the top cover 14 and the bottom cover 16 in the gear motor assembly 10, as further described below.

A DC motor 22 is positioned between the top cover 14 and the gear cover 20. A gear train 18 is positioned generally underneath the motor 22, between the bottom cover 16 and the gear cover 20, separated from the motor by the gear cover 20. The gearbox 12 is typically made of an ABS (acrylonitrile butadinene styrene) copolymer or other such engineering plastics and may be designed with or without reinforcement, as necessary. The gearbox 12 may further include corner tabs 15 for interlocking the gear motor assembly 10 to the electromechanical device that it operates. While shown on the bottom cover 16, the corner tabs 15 may be located at other places on the gearbox 12, for example, on the top cover 14.

As shown in FIG. 1, the DC motor 22 is mounted directly to the gear cover 20. The DC motor 22 converts an electrical power into mechanical rotation of its output shaft. Also mounted to the gear cover 20 is a circuit board 25 for rectifying and filtering constant DC voltage to the motor 22. The circuit board 25 is typically connected to either a 120 or 240 alternating current voltage and converts such voltage to a constant DC voltage that is feed to the motor 22. The rating of the DC motor 22 may have direct current of twelve volts (12V), twenty-four volts (24V), thirty-six volts (36V) or forty-eight volts (48V). The circuit board may be omitted if right DC voltage is available within the device that uses the gearmotor such as refrigerator.

Extending from the DC motor 22 is an output shaft 24 that has a first 45° helical gear 26 mounted thereto. The first helical gear 26 operably engages a second 45° helical 28 gear at a right angle. The second helical gear is linked to a third pinion 30 by transmission shaft 32 that extends between the second and third helical gears 28 and 30 through a hole in the gear cover 20. The third helical gear 30 then operably engages a first cluster gear 34, which engages a second cluster gear 36. The second cluster gear 36 then engages an output gear 38, which has a drive shaft 40 mounted thereto. The first and second helical gears 26 and 28, the third pinion gear 30, the first and second cluster gears 34 and 36 and the output gear 38 form the gear train 18, which wraps around the DC motor 22. The output shaft 24 is shown in FIG. 1 as being at 90° with the axis of the second helical gear 28. However, the effective angle between the shaft 24 and the second helical gear 28 need not be 90°, for example, the angle may be concave, such as 70°, or convex, such as 100°, in which case the angles of the mating helical gear 26, 28 can be altered as needed (as discussed more below) to maintain proper orientation of the gear motor assembly 10 in a given operating environment.

Helical gears are standard available gears. The degree of the helical gears is determined by the angle of the grooves in the teeth of the gears relative to the axis of the gear shaft. Although the above describes the utilization of 45° helical gears, the gear ratio can be altered depending on design constraints to permit more or less back drive, for example, by using a 30°, 60° helical gear combination. Other gears, besides helical gears, such as crown and bevel gears may also be utilized as they too permit backdrive. Although the design described herein has a first helical gear and a second helical gear arranged at 90°, it is possible to arrange such gears at angles that do not result in the gears being positioned at a 90° angle from one another, for example the gears may be positioned at 70° angle from one another by using any combination of helical gears such that the sum of helical angels of such gears would be equal to the angle between their axises, for example a 30°, 40° helical gear combination, or for example at 100°, by using, for example, a 60°, 40° helical gear combination.

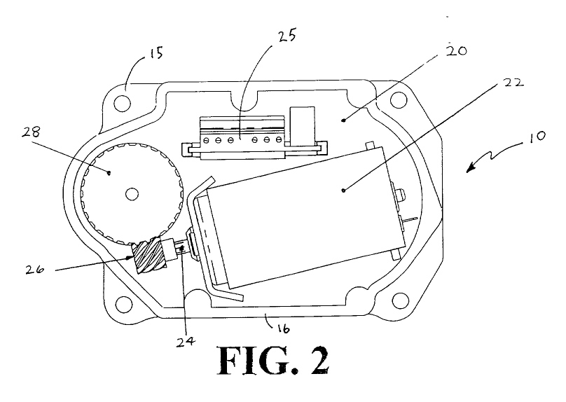

FIG. 2 is a top view of the gear motor assembly illustrated with the top cover of the gearbox removed. This view best illustrates the motor 22, as it appears mounted to the gear cover 20. The motor 22 has a first helical gear 26 attached to the output shaft 24 of the motor 26. The first helical gear 26 then engages a second helical gear 28 at a right angle, defined by the angle between the axis of the motor's output shaft 24 and the first stage gear, which in this instance, is the second helical gear 28.

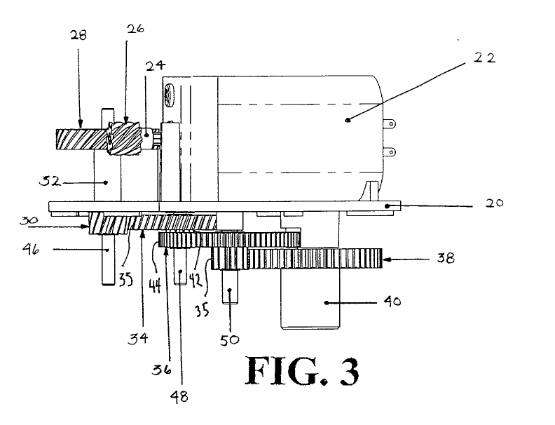

FIG. 3 is a side view of the gear motor assembly as illustrated with the top and bottom cover of the gearbox removed. This view best illustrates the motor 22, as it appears mounted to the gear cover 20, relative to the gear train 18. Further, this view best illustrates the operable engagement of the teeth of the gears in the gear train 18.

As seen in FIG. 3, the DC motor 22 rests upon the gear cover 20. An output shaft 24 extends from the motor 22 and has a first 45° helical gear 26 mounted thereto. The teeth of the helical gear 26 engage the teeth of a second helical pinion 28 gear at a right angle. Thus, as the output shaft 24 of the motor 22 rotates, the teeth of the first helical gear 26 engage the teeth of the second helical gear 28, causing the second helical gear 28 to rotate. Extending from the second helical gear 28 is a transmission shaft 32 that extends through a hole in the gear cover 20. A third pinion gear 30 is attached to the opposing end of the transmission shaft 32 at the underside of the gear cover 20 opposite the motor 20. The second helical gear 28 and the third pinion 30 are held in place through a pin 46, that engages the inside of the bottom cover 16 and supported on the other end in the top cover 14 to stabilize the second and third pinion gears 28 and 30 (connected via the transmission shaft 32). The teeth of the third pinion 30 interconnect with the upper teeth 33 of a first cluster gear 34. Like the second and third pinion gears 28 and 30, the first cluster gear 34 is supported by a pin 48 that extends between the gear cover 20 and the bottom cover 16 to stabilize the first cluster gear 34. Bottom teeth 42 of the first cluster gear 34 then engage the top teeth 35 of a second cluster gear 36, which is also supported between the gear cover 20 and the bottom cover 16 by a pin 50. Bottom teeth 44 of the second cluster gear 36 interconnect with the teeth 35 of an output gear 38, which has an output shaft 40 mounted thereto. While the above description, for illustrative purposes, shows the use of a first and second cluster gear 34 and 36, one or more cluster gears can be utilized. The present invention is not limited to the use of two cluster gears. The output gear 38 may also be directly engaged with the third pinion gear 38 without additional gear clusters. The gears described herein are typically constructed of either metal, nylon or other plastic, depending upon the gear positioning and related loads.

In operation, the motor 22 turns the output shaft 24, having the first pinion gear 26 attached thereto. The first pinion gear 26 drives the second pinion gear 28, which causes the third pinion gear 30 to rotate as it is directly connected to the second pinion gear 28 via the transmission shaft 32. The third pinion gear 30 then drives the first cluster gear 34, which drives the second cluster gear 36. The second cluster gear 36 drives the output gear 38, which causes the drive shaft 40, extending therefrom, to rotate.

The present invention can be configured for use in connection with an ice crusher (not shown) or ice dispenser (not shown) of, for example, a conventional refrigerator or freezer. When used with an ice crusher or ice dispenser, the gearmotor is mounted in the freezer compartment or outside of the compartment by means of tabs with screws or other securing method. The output shaft of the gearmotor is then connected directly or through a drive shaft to ice crushing blades and/or auger or other such crushing mechanism, in the case of the ice crusher, or a dispensing mechanism in the case of a drive shaft. Use of a DC motor allows for a simple reversing of the shaft rotation if desired providing an ice crushing or an ice dispensing functions.

It is to be understood that the description of the present invention and the embodiments stated herein are not to be interpreted as limiting the scope of the invention in any way. It is apparent to those skilled in the relevant arts that many modifications and adaptations of the invention described herein can be made without departing from the scope of the invention as defined by the claims herein.

What is claimed is:

1. A gear motor assembly comprising:
a motor having an output shaft;
a first helical gear attached to the output shaft of the motor;
a second helical gear engaged by the first helical gear;
a third pinion gear attached to the second helical gear by a transmission shaft; and
an output gear engaged by the third pinion gear, the output gear having a drive shaft extending therefrom.

2. The gear motor assembly of claim 1 further including at least one cluster gear positioned between the third pinion gear and the output gear.

3. The gear motor assembly of claim 1 where the axis of the first helical gear is positioned at an angle at least thirty degrees (30°) but no more than one-hundred (100°) degrees from the axis of the second helical gear.

4. The gear motor assembly of claim 1 where the axis of the first helical gear is positioned at an angle at least ninety (90°) from the axis of the second helical gear.

5. The gear motor assembly of claim 1 where the first and second helical gears are both forty-five degree (45°) helical gears.

6. The gear motor assembly of claim 1 where the first helical gear is a thirty degree (30°) helical gear and where the second helical gear is a sixty degree (60°) helical gear.

7. The gear motor assembly of claim 1 where the first helical gear is a sixty degree (60°) helical gear and where the second helical gear is a thirty degree (30°) helical gear.

8. The gear motor assembly of claim 1 where the first helical gear is a thirty degree (30°) helical gear and where the second helical gear is a forty degree (40°) helical gear.

9. The gear motor assembly of claim 1 where the first helical gear is a forty degree (40°) helical gear and where the second helical gear is a thirty degree (30°) helical gear.

10. A gear motor assembly for use in connection with an ice crusher, the gear motor assembly comprising:
a motor having an output shaft;
a first helical gear attached to the output shaft of the motor;
a second helical gear engaged by the first helical gear;
a third pinion gear attached to the second helical gear by a transmission shaft;
an output gear engaged by the third pinion gear, the output gear having a drive shaft extending therefrom; and
a crushing mechanism attached to the output gear for crushing ice contained in the ice maker.

11. The gear motor assembly of claim 10 further including at least one cluster gear positioned between the third pinion gear and the output gear.

12. The gear motor assembly of claim 10 where the axis of the first helical gear is positioned at an angle at least thirty degrees (30°) but no more than one-hundred (100°) degrees from the axis of the second helical gear.

13. The gear motor assembly of claim 10 where the axis of the first helical gear is positioned at an angle at least ninety (90°) from the axis of the second helical gear.

14. The gear motor assembly of claim 10 where the first and second helical gears are both forty-five degree (45°) helical gears.

15. The gear motor assembly of claim 10 where the first helical gear is a thirty degree (30°) helical gear and where the second helical gear is a sixty degree (60°) helical gear.

16. The gear motor assembly of claim 10 where the first helical gear is a sixty degree (60°) helical gear and where the second helical gear is a thirty degree (30°) helical gear.

17. The gear motor assembly of claim 10 where the first helical gear is a thirty degree (30°) helical gear and where the second helical gear is a forty degree (40°) helical gear.

18. The gear motor assembly of claim 10 where the first helical gear is a forty degree (40°) helical gear and where the second helical gear is a thirty degree (30°) helical gear.

19. A gear motor assembly for use in connection with an ice maker, the gear motor assembly comprising:
a motor having an output shaft;
a first helical gear attached to the output shaft of the motor;
a second helical gear engaged by the first helical gear;
a third pinion gear attached to the second helical gear by a transmission shaft;
an output gear engaged by the third pinion gear, the output gear having a drive shaft extending therefrom; and
a dispensing mechanism attached to the output gear for dispensing ice contained in the ice maker.

20. The gear motor assembly of claim 19 further including at least one cluster gear positioned between the third pinion gear and the output gear.

21. The gear motor assembly of claim 19 where the axis of the first helical gear is positioned at an angle at least thirty degrees (30°) but no more than one-hundred (100°) degrees from the axis of the second helical gear.

22. The gear motor assembly of claim 19 where the axis of the first helical gear is positioned at an angle at least ninety (90°) from the axis of the second helical gear.

23. The gear motor assembly of claim 19 where the first and second helical gears are both forty-five degree (45°) helical gears.

24. The gear motor assembly of claim 19 where the first helical gear is a thirty degree (30°) helical gear and where the second helical gear is a sixty degree (60°) helical gear.

25. The gear motor assembly of claim 19 where the first helical gear is a sixty degree (60°) helical gear and where the second helical gear is a thirty degree (30°) helical gear.

26. The gear motor assembly of claim 19 where the first helical gear is a thirty degree (30°) helical gear and where the second helical gear is a forty degree (40°) helical gear.

27. The gear motor assembly of claim 19 where the first helical gear is a forty degree (40°) helical gear and where the second helical gear is a thirty degree (30°) helical gear.
